(19) United States
(12) Patent Application Publication
(10) Pub. No.: US 2005/0281381 A1
(43) Pub. Date: Dec. 22, 2005

(54) Method for automatically detecting a structure in medical imaging methods, computed tomograph, workstation and computer program product

(76) Inventor: Lutz Guendel, Erlangen (DE)

Correspondence Address: HARNESS, DICKEY & PIERCE, P.L.C., P.O.BOX 8910, RESTON, VA, 20195, US

(21) Appl. No.: 11/144,829

(22) Filed: Jun. 6, 2005

(30) Foreign Application Priority Data
Jun. 7, 2004 (DE) 10 2004 027 710.9

(51) Int. Cl. G01N 23/00; H05G 1/60; H01J 35/10

(52) U.S. Cl. 378/131

(57) ABSTRACT

A method is proposed for automatically detecting a structure in an image. The method includes providing a starting region in a displayed image and prescribing a target structure. To make such a method more effective and more reliable, the concept proposed here restricts the starting region to a search region. Only then is there provision for a structure which is similar to the target structure to be automatically sought in the search region.

The present application hereby claims priority under 35 U.S.C. §119 on German patent application number DE 10 2004 027 710.9 filed Jun. 7, 2004, the entire contents of which is hereby incorporated herein by reference.

### FIELD

The invention generally relates to a method for automatically detecting a structure in medical imaging methods. The invention also generally relates to a computed tomograph, a workstation and/or a computer program product.

### BACKGROUND

Modern medical imaging methods normally provide images in digital form. In particular, computed tomography images are provided in digital form and can thus be processed further directly in a computer or in a workstation. From the original images, it is possible to obtain images in a new orientation with two-dimensional or three-dimensional display (2D display, 3D display) in order to provide a suitable overview for the examiner. Such displays are intended, in particular, to form the basis of subsequent diagnosis within the context of a monitor examination.

Advantages of computed tomography result, in particular, from the fact that there are no superposition problems as in the case of conventional radiography. Further, computed tomography provides the advantage of undistorted display regardless of different magnification factors associated with the recording geometry in radiography.

In the meantime, a series of different procedures have become established for 3D image display and processing. For these procedures, a computed tomograph has suitable control elements, e.g. a computer mouse or other control media. A workstation for image display and processing of computed tomography images is equipped with appropriate software in the form of a computer program product and a user interface on a screen with appropriate control elements to which functions are assigned.

Computed tomography (CT) first of all normally provides two-dimensional sectional images of the transverse plane of a body to be examined as direct recording plane. In this case, the transverse plane of a body is arranged essentially at right angles to the longitudinal axis of a body. Two-dimensional sectional images in a plane at an angle that has changed in comparison with the transverse plane and/or those which are calculated with a different, particularly broader, layer thickness than the original layer thickness are normally called multiplanar reformations (MPR).

One option which is fundamental to diagnosis is interactive inspection and evaluation of the image volume, usually under the control of an appropriate control element. The examiner can use such control elements—in a similar manner to guiding a sound head in ultrasound—to feel his way to anatomized structures and pathological details and can move forward and backward to select that image in which a detail of interest is presented most clearly, that is to say by way of example is displayed with the highest contrast and the largest diameter.

An extended form of two-dimensional display involves putting together layers (slabs) of arbitrary thickness from thin layers. For this, the term “sliding thin slab” (STS) has become established.

All 2D displays have the advantage that the computed tomography values are displayed directly and without corruption. Any interpolations or averages formed over a plurality of layers are negligible in this case. Thus, there is always simple orientation in the evaluation volume, which is also called the volume of interest (VOI), and in the associated 3D data volume and also explicit interpretability of the image values. This type of monitor examination is work-intensive and time-consuming, however.

By contrast, the most realistic presentation of the evaluation volume possible can be achieved through three-dimensional display of the evaluation volume. Although 3D image display and processing is normally the prerequisite for specific elaboration of diagnostically relevant details, the latter examination is normally performed in a 2D display.

In the case of 3D image display and processing, a 3D data volume is normally provided which is taken as a basis for displaying the evaluation volume. The examiner preferably prescribes an observer position from which he wishes to observe the evaluation volume. In particular, the examiner normally has a search beam at his disposal. In this example, a two-dimensional image is calculated which is at right angles to the search beam and is intended to convey a spatial impression.

To construct such a display pixel by pixel (also: voxel—acronym for volume element) in the image plane, all CT values along the search beam through the 3D data volume need to be taken into account and assessed for each beam from the observer to the respective pixel. The examiner normally prescribes a pixel value, e.g. a contrast value, which he selects in suitable fashion for displaying a pixel. The repetition (inherent to the method) of this process shows the examiner a collection of pixels corresponding to the search beam on the basis of the prescribed pixel values within the context of a CT value profile for the search beam, that is to say shows a 3D display of the body region/evaluation volume of interest (VOI).

All 3D displays may, that is to say within the context of a secondary application, be designed either as a central projection or as a parallel projection. For a parallel projection, “maximum intensity projection” (MIP) or generally “volume rendering” (VR) is particularly suitable.

In the case of MIP, the pixel with the highest CT value is determined in the projection direction along the search beam. In that case, the pixel value thus corresponds to the maximum CT value on the search beam.

In the case of VR, not just a single pixel is chosen for each individual search beam coming from the observer's eye. Rather all CT values along the search beam can, with suitable weighting, deliver a pixel as a contribution to the resulting image.

Freely selectable and interactively alterable transfer functions are used to assign opacity and color to each pixel value. It is thus possible, by way of example, to select normal soft tissue to be largely transparent, contrasted vessels to be slightly opaque and bones to be very opaque. Preferable central projections may be attained, by way of example, by “surface shaded display” (SSD) or by “perspective volume rendering” (pVR) (or else “virtual endoscopy”). Accordingly, there is the SSD or else the pSSD used in virtual endoscopy.

SSD is threshold-based surface display, where a pixel is prescribed by prescribing a pixel value in the form of a threshold. For every search beam through the present 3D data volume, that pixel is determined at which the prescribed pixel value in the form of a threshold value is reached or exceeded for the first time as seen by the observer.

One basic difference between SSD and VR is that in the case of SSD only one threshold is defined, but the surface is displayed opaque. In the case of VR, on the other hand, a plurality of threshold regions are defined and these are assigned colors and transparencies.

“Virtual endoscopy” is intended to permit a perspective view of the close surroundings of the virtual “endoscope head”. Unlike in the case of the actual endoscope, structures can be observed from different directions and while moving. “Fly throughs”, which are intended to give the impression of a virtual flight through the VOI, are possible. This is not only esthetic and instructive, but also may be of diagnostic value.

An examiner looking for a detail of interest in the form of a structure is often reliant on having such a structure detected automatically in the available digital data material. Such a search is usually performed by providing a starting region in an image display and prescribing a target structure. In this case, the examiner firstly has only limited opportunity to restrict the data material in the field of medical imaging methods, since it is normally available to him as a 3D data volume, as explained above. Secondly, the structures in the field of medicine are found to be multifarious and complex. Nevertheless, for effective performance of automatic detection, one is reliant on specifying a target structure in as abstract a form as possible so as not to restrict the search for the structure of interest too greatly during automatic detection.

In addition, the body to be examined has normally been prepared in suitable fashion, e.g. has had a contrast agent added to it, and is subject to a certain chronological process during the examination itself. The preparation is intended, in particular, to identify starting regions of interest.

However, sequences over time can mean that the preparation changes and, in particular, results in the preparation of body regions which are fundamentally not of interest. On the basis of the circumstances explained above, automatic detection of a structure as part of a search process in the entire starting region often leads to “false positive” results. That is to say that, having prescribed a target structure for a search process, the automatic detection in the entire starting region, i.e. using the entire data volume, often provides the examiner with results which, although they are correct within the meaning of the search as such, are found to be incorrect from the point of view of the medical examination. That is to say that, although the detected structure possibly corresponds to the prescribed target structure, the detected structure is nevertheless found to be a detail which is not of interest, or is situated in a body region which is not of interest. It would therefore be desirable to avoid finding “false positive” results during the automatic detection of a structure in medical imaging methods.

### SUMMARY

An object of an embodiment of the invention includes specifying a method and/or an apparatus for automatically detecting a structure in medical imaging methods in which the automatic detection is simultaneously effective and reliable.

An object may be achieved by a method including:
a starting region in an image display is provided on the basis of a 3D data volume,
a target structure is prescribed,
the starting region is restricted to a search region which now comprises only an evaluation volume of interest,
the evaluation volume of interest is segmented into a number of subsegments of the evaluation volume of interest as part of a computer-automated search function,
the evaluation volume of interest is restricted to a search region which comprises a single subsegment of the evaluation volume of interest,
a structure which is similar to the target structure is automatically sought in the search region.

An embodiment of the invention includes consideration that a provided image display already allows the examiner to restrict a starting region which essentially covers the entire image display to a search region. This is because the starting region is often much too large and normally covers the entire image display in practice.

In this context in one example embodiment, the examiner is able to restrict the search region such that it covers an evaluation volume of interest. In one example embodiment, the size of the search region corresponds approximately to the size of the evaluation volume of interest. The starting region in the image display may be restricted to a search region which excludes body regions which are not of interest. In a particular embodiment, the starting region in the image display may be restricted to a search region which now covers only an evaluation volume of interest.

By way of an example embodiment, the examiner is thus able to surround the colon region as an evaluation volume of interest with a restricted search region. By doing this, he excludes “false positive” results which might be found in the region of the lung, for example, during automatic detection.

In this context, an example embodiment of the invention has recognized that the proposed method is actually made more reliable and more effective by virtue of the fact that a starting region in the image display is restricted to an expediently selected search region even before the automatic search.

The examiner may, for example, surround an even more specific and, in particular, smaller evaluation volume with a search region. As an evaluation volume of interest, it is possible to specify a segment of the colon, e.g. the large intestine or the small intestine, for example directly, or an even smaller intestinal segment. By way of example, a starting region can be restricted directly to a search region which now surrounds only a specific segment of the large intestine which is of interest. Only then does the automatic searching for a structure similar to the target structure in the search region take place in this example. This can be done by segmenting the evaluation volume.

In addition, this is best done as part of a computer-automated search function. This has the advantage that although the data volume, which cannot be influenced per se, is not altered the search relates only to a data volume which is restricted to the data volume of the evaluation volume of interest. That is to say that the search may be limited to the search region purely in the 3D data volume—regardless of the respective visual display chosen (SSD, VR).

What are taken into account, however, are basic geometric or medical facts, e.g. if a structure that is to be sought may be situated only on one surface of a colon. This makes the search not only faster but also more reliable, since “false positive” results are avoided from the outset in other body regions, outside of the evaluation volume of interest.

The method explained is found to be particularly effective for methods for image display and processing in computed tomography. With these type of imaging methods, the image displays—as explained at the outset—are so complex that an examiner is reliant on the automatic detection of a structure to a particular extent. This is particularly the case with all 3D image display and processing, that is to say with methods in which the image display is based on a 3D data volume. This is because improving the automatic detection of structures of interest improves monitor examination within the context of a 3D image display.

In that case, it would, in particular, no longer be absolutely necessary to carry out an examination in a 2D display. Diagnostically relevant details could be obtained effectively and reliably as an actual conclusion in an advantageous 3D dimensional display of the evaluation volume.

Advantageous developments of embodiments of the invention specifically indicate advantageous options, particularly for implementing the search operation within the context of automatic detection.

In one example embodiment, the target structure is prescribed within the context of classification of fundamental geometric and/or medical properties of the structure. In practice, the target structure is a stylized, simplified reproduction of the structure which is to be sought. A geometric property relates particularly to the shape and size of the structure. A medical property may relate particularly to the type and surface condition of the structure.

By way of example, to find a structure in the form of a polyp, it is possible to look for a round target structure. In the case of the structure of an air-filled intestinal tract, it would be necessary to look for a target structure in the form of an elongate tube. A target structure is largely easy to define within the context of geometric and/or medical properties, and it should simultaneously be ensured that the search is not restricted too greatly.

The concept explained is advantageously suitable for searching for a lesion. That is to say that within the context of one development the structure is a lesion in particular. In principle, a lesion is to be understood to include any object of interest. In particular, a lesion is to be understood to include any abnormal structure or change of structure for example in an organ, particularly on account of an injury or an illness. A lesion can often be described and characterized very precisely in its shape and size using a target structure. The automatic detection of lesions thus has provision, in an embodiment, for a computer-automated search function for a particular, geometric target structure which is characteristic of the lesion.

As explained above, variable preparation over time of a body which is to be examined, for example, may make it advantageous to segment the evaluation volume. In particular, the large intestine is one possible segment of an evaluation volume and may be used as an example here. In practice, a large intestine, in particular, is not present as a unit but rather only as a collection of subsegments, which are possibly separate from one another, e.g. as a result of inadequate preparation, tumors or spasms. Since the subsegments normally have different lengths and positions, the number of subsegments (which are possibly separate from one another) can be defined interactively as a single evaluation volume and can be surrounded with a restricted search region. The remaining, undefined parts are thus implicitly defined as not belonging to the evaluation volume and are advantageously ignored in a subsequent search.

On the other hand, the method may also have provision for a starting region in the image display to be restricted to a search region which covers a single subsegment of the evaluation volume of interest. This type of procedure is found to be advantageous when the body part to be examined in the evaluation volume is of a size which needs to be examined in separate sections or is of a shape which is naturally in separate sections.

These may be ramifications of a structure of interest, for example a bronchial system or bronchial tree or a cisterna. These may also be constrictions of hose-clip type in a tubular structure, for example in a colon or in a part thereof.

In one embodiment, the method explained for automatic detection of a structure thus involves successive performance including:
a starting region in an image display is provided,
a target structure is prescribed,
a structure which is similar to the target structure is automatically sought in a search region which is restricted in comparison with the starting region.

The search may be directed at a lesion. If “false positive” results are available, fundamental geometric and/or medical properties of the structure are classified to a greater extent and the target structure is prescribed again, possibly in more detail.

It is also possible to restrict the starting region to a search region to an even greater extent. The evaluation volume may be immediately segmented or split into subsegments, and a starting region may be restricted to a search region which, in practice, now comprises only a single or a plurality of segments or subsegments. Preferably, a structure similar to the target structure is automatically sought in the search region only then, and it should then be free of “false positive” results.

The method proposed here can eliminate “false positive” results effectively and reliably.

Advantageously, the examiner may be permitted, within the context of the concept explained, to make an interactive selection of the structure and/or an interactive selection of a segment. In order to render selection as comprehensible as possible for the examiner, an assessment and/or sorting can be produced for the selection. That is to say that the results found could be assessed in terms of their relevance. The aforementioned geometric and/or medical properties could be used to produce an assessment which indicates how likely it is that the result found is not a “false positive” result. The results found could be provided for the examiner in the course of the selection according to falling likelihood, sorted sequentially.

Within the context of future applications, the concept proposed here has a high level of potential particularly for pVR. In particular, the concept proposed here is found to be advantageous in an imaging method in which a 3D image display is produced in the form of a virtual endoscopy. Virtual endoscopic views, which are also called endoluminal views, are perspective VR (pVR) in practice. A primary area of use for this technology is anatomical structures which are also accessible to endoscopes. Examples of these include the bronchial tree, larger vessels, the colon and the paranasal sinus system. In addition, virtual endoscopy is also used in regions such as the renal cisternae and in the gastrointestinal region, which are not directly accessible to endoscopes.

In particular, the method is found may be advantageous for imaging methods which start from a 3D data volume obtained using a contrast agent. This relates particularly to colonoscopy, bronchoscopy and cisternoscopy. In this regard, image display and processing of medical images, particularly computed tomography images, of a colon or of a bronchial system or of a cisterna take place in the course of the method explained. It should nevertheless be clear than the concept explained and claimed here is likewise useful for image display and processing of medical images in which the data volume has been obtained using other modalities. The 2D or 3D data volume may also be obtained in the course of a magnetic resonance examination or nuclear magnetic resonance tomography, for example.

In at least one embodiment, the invention includes an object for the apparatus for a computed tomograph or magnetic resonance tomography, which has at least one control element for carrying out at least one embodiment of the method explained above.

For the apparatus, an embodiment of the invention also produces a workstation for image display and processing of computed tomography or magnetic resonance tomography images which has at least one control element for carrying out at least one embodiment of the method explained above.

A control element is to be understood to include, in particular, a software device/method and/or hardware device/method individually or in combination, which can be used to execute and control one of the method steps cited above.

An embodiment of the invention also produces a computer program product for image display and processing of computed tomography or magnetic resonance tomography images, which has at least one program module for carrying out at least one embodiment of the method explained above.

### BRIEF DESCRIPTION OF THE DRAWINGS

Example embodiments of the invention are described below with reference to the drawings. Specifically, in the drawings:

FIG. 1 shows a first example application of an example embodiment of the method, where the starting region in the image display is restricted to ever smaller search regions;

FIG. 2 shows a second example application of an example embodiment, where a starting region in the image display is restricted firstly to a search region which includes a number of segments and secondly to a search region which comprises a single segment; and

FIG. 3 shows a flowchart of an example embodiment of the proposed concept.

### DETAILED DESCRIPTION OF THE EXAMPLE EMBODIMENTS

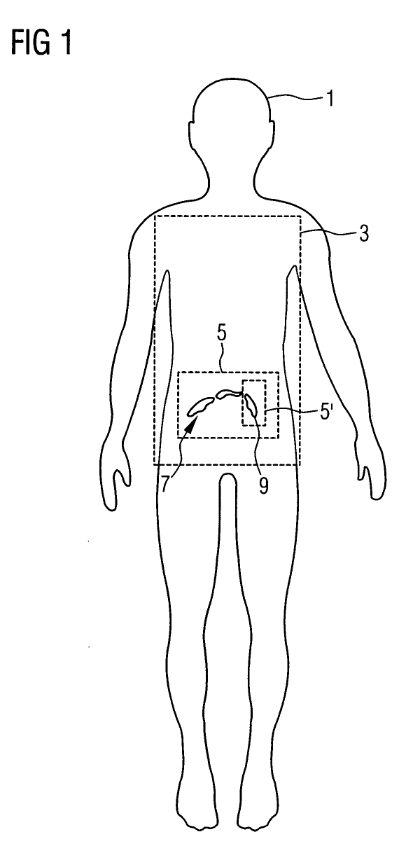

FIG. 1 illustrates an example application of the proposed concept within the context of an example embodiment. In the present case, an image display 1 of the human body is shown using computed tomography. Particularly in the case of a monitor examination, the examiner is reliant on the automatic detection of a structure. To this end, he prescribes a target structure, and the concept allows him to search automatically for a structure which is similar to the target structure in the image display 1.

Normally, the examiner is reliant on searching for the target structure in a starting region 3 in the image display 1, i.e. on allowing the target structure to be sought automatically by computer. In this case, the prescribed target structure is compared with a structure which is similar to the target structure in the starting region 3. This can lead to “false positive” results on account of the complexity of the medical circumstances which was explained above.

The proposed example concept now allows the examiner to restrict the starting region 3 in the image display to a search region 5 first of all, with the search region being just large enough for it now to cover only an evaluation volume of interest 7 in practice. In the present example case, the evaluation volume 7 is indicated in the form of a colon. That is to say that the present example in FIG. 1 explains the proposed concept within the context of colonoscopy by way of example.

In addition, the procedure explained here can be applied to other medical imaging methods, particularly to bronchoscopy and cisternoscopy. Furthermore, the procedure described here can be transferred to methods which follow other modalities, such as magnetic resonance or nuclear magnetic resonance methods. The imaging method of computed tomography explained here for the colon region uses contrast agents, in particular, such as water, CO₂ or air, as intestine fillers in order to be able to show the evaluation volume in detail.

The process shown in FIG. 1 allows the examiner, particularly at first, to exclude “false positive” results in the lung by restricting the starting region 3 to the search region 5.

In addition, a further problem arises in colonoscopy, which may arise in quite similar fashion in other examinations and will be explained by way of example with reference to colonoscopy. Thus, when automatically detecting polyps in the large intestine, an examiner is reliant on the use of air, for example, as contrast agent and on searching for polyps in air-filled tubes (large intestine). In this case, the polyp is the structure which is to be sought.

As target structure, the examiner is generally reliant on searching for round shapes. Despite restricting the starting region 3 to the search region 5, it may not be possible to exclude “false positive” results. Particularly in the case of colonoscopy, which uses 3D data volume obtained using a contrast agent, it is found that the use of contrast agent leads to further problems. This is because the example explained has the situation that the ileocecal valve situated between the large intestine and the small intestine can allow air or CO₂ used as contrast agent, which is injected into the large intestine in order to detect polyps, to escape into the small intestine.

For this reason, target structures are sought and found in the small intestine too. Such target structures are obviously “false positive” results, since although they are a round shape within the meaning of the desired target structure they are not polyps in the large intestine. Round structures have admittedly been found in an air-filled tube (small intestine), but no polyps of the large intestine.

It has therefore been found to be advantageous to segment the evaluation volume 7. In this case, the evaluation volume 7 in the image display is restricted to a search region 5′ covering a segment 9 of the evaluation volume of interest 7. In the present case, the examiner would restrict the search region to a segment 9 of the colon in the form of the large intestine. To this end, the workstation has an appropriate controller or input device, e.g. a computer mouse or a keyboard, which allows the examiner to restrict the search region 5 in the image display further, e.g. using a zoom window. FIG. 1 indicates this in sketched form by the further search region 5′, the further search region 5′ now comprising only a segment 9 (large intestine) of the evaluation volume of interest 7 (colon) in practice.

In this regard, the computer program product implemented in the computed tomograph and/or in the workstation provides a program module for automatically searching for a structure which is similar to the target structure in the search region 5′. In this case, the structure chosen now needs to be the large intestine 9, and the target structure sought needs to be the longest air-filled tube that is present, for example.

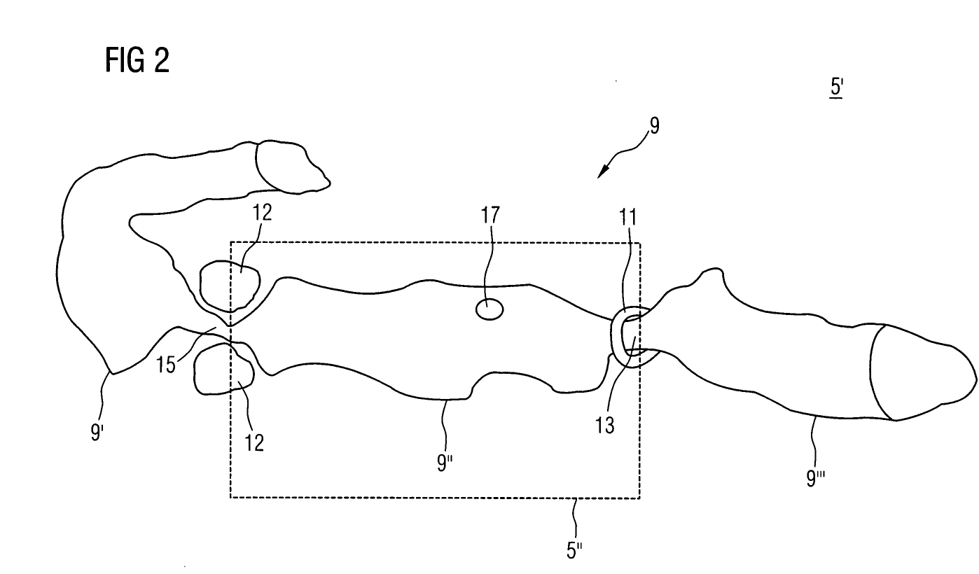

FIG. 2 shows a further procedure in the course of monitor examination using the explained concept. What is shown is the further search region 5′ with the segment 9 in the form of the large intestine for the evaluation volume of interest 7 in the form of a colon.

It has been found that, by way of example, colon spasms or intestinal closures or lack of contrast agent at the time of data generation means that the large intestine is not fully passable. For this reason, the search results do not normally relate to the entire large intestine, or could even indicate parts of the small intestine. On the other hand, the large intestine is naturally segmented into further subsegments 9′, 9″ and 9′″, which may not be in the form of a unit but rather may be separate from one another.

This is because the large intestine is a tubular structure with hose-clip-type body features. This may be a contracting muscle 11, for example, which constricts the large intestine into further subsegments 9″ and 9′″ at points 13 in the manner of a hose clip.

The same may likewise apply to a tumor 13 situated outside of the intestine, for example, which again constricts the intestine in the manner of a hose clip at the point 15. It may naturally thus be the case in the field of medical imaging methods that an evaluation volume of interest 7 (colon) is in multiple segments and a segment (large intestine) is in turn in the form of a plurality of noncohesive subsegments 9′, 9″, 9′″. The method therefore makes provision for a number of subsegments 9′, 9″, 9′″ which are separate from one another to be able to be surrounded by a search region.

Within the context of the present embodiment, it is also possible for the examiner to assist the search result interactively. The examiner is able, in the case of the example shown in FIG. 2, to select the large intestine subsegments 9′, 9″ and 9′″ through interactive selection and deselection until he finds the subsegment with the detail which is of interest to him, for example a lesion 17 in the form of a polyp. In that case, the starting region 3 in the image display 1 is thus restricted to a search region 5″ which, in practice, now covers only the single subsegment 9″ of the evaluation volume of interest 7. Only then will the examiner begin the computer-automated search for a structure (polyp) similar to the target structure (round structure) in the search region 5″. The lesion 17 is found automatically—and in this context particularly effectively and at the same time reliably.

In the example explained above, there has thus first of all been a search for a lesion 17 in the form of a polyp. Secondly, a subsegment 9″ of the evaluation volume 7 in the form of a longest available air-filled tube has been interactively selected. Both opportunities in the method may advantageously be used by the examiner to allow particularly reliable automatic detection.

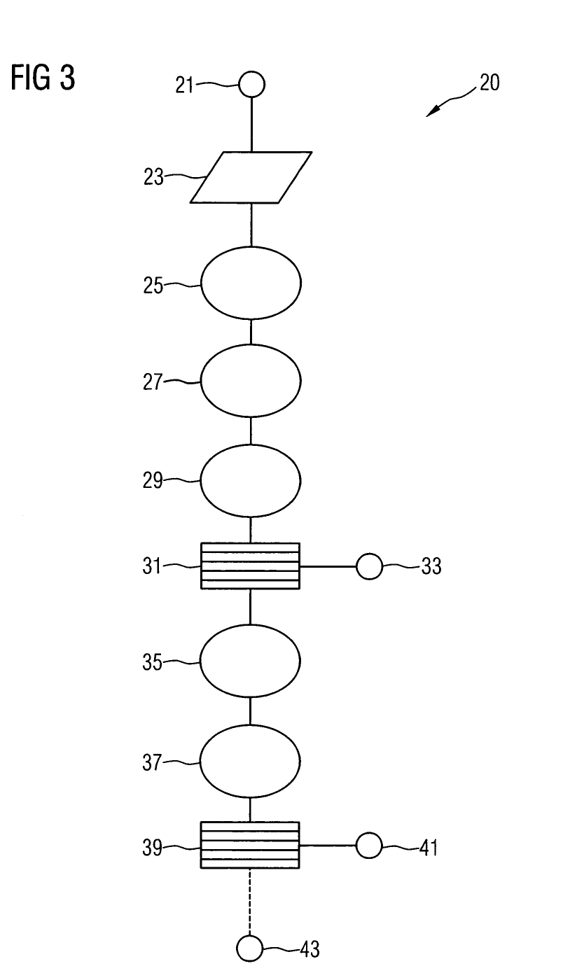

FIG. 3 shows a flowchart of an example embodiment of the proposed concept within the scope of a flow schedule 20. After the method starts 21, a starting region in an image display is first provided in method step 23. This may be a starting region 3 in an image display 1 in FIG. 1, for example.

A target structure is then prescribed in method step 25. Depending on requirements, this may be a lesion 17 (shown in FIG. 2) in the form of a polyp, for example. It is left to the examiner to classify the target structure in appropriate fashion in method step 23. In this case, all fundamental geometric and/or medical properties of the structure are available to him in order to define the target structure.

In the course of method step 27, the examiner can then restrict the starting region in the image display to a search region. The search region surrounds or is preferably limited to an evaluation volume of interest. As explained with reference to FIGS. 1 and 2, the starting region 1 can be restricted as far as an evaluation volume 7 of interest (colon) or else to a segment 9 (large intestine) or to subsegments 9′, 9″, 9′″ thereof. Only method step 29 does an automatic search take place for a structure which is similar to the target structure in the search region, which may be the evaluation volume of interest 7, a segment 9 or a subsegment.

In method step 31, the examiner in this embodiment is offered a selection and is able to select the structure interactively. Advantageously, the method may have provision for the automatic search actually to produce an assessment and/or sorting for the selection. The result of an assessment of the lesion 17 in FIG. 2 may therefore be very positive and the assessment of other features (not shown) in the search region 5″ may turn out to be rather poor. In the case of present examples, such an assessment could be oriented to checking whether the feature found is a round shape.

If the examiner has found something in this way, he can terminate the method in method step 33. If the examiner has not yet found anything, he can restrict the search region 5, 5′, 5″ further in method step 35 in the case of the example embodiment in FIG. 3, in order to start an automatic search again in a further method step 37. As a result, in method step 39 the examiner would again be provided with an assessed and sorted selection of search results, which was explained above. If the result is satisfactory, the examiner could terminate the method in method step 41.

This procedure can be repeated as often as desired until the method is successfully concluded in method step 43.

A method for automatically detecting a structure in medical imaging methods involves providing a starting region 3 in an image display 1 and prescribing a target structure. To make such a method more effective and more reliable, the concept proposed here involves first restricting the starting region 3 to a search region 5, 5′, 5″. Only then is there provision for an automatic search for a structure which is similar to the target structure in the search region 5, 5′, 5″.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for automatically detecting a structure in an image, the method comprising:
providing a starting region in a displayed image on the basis of a 3D data volume;
prescribing a target structure;
restricting the starting region to a search region including only an evaluation volume of interest;
segmenting the evaluation volume of interest into a number of subsegments of the evaluation volume of interest as part of a computer-automated search function;
restricting the evaluation volume of interest to a search region including a single subsegment of the evaluation volume of interest; and
automatically detecting a structure which is similar to the target structure in the search region.

2. The method as claimed in claim 1, wherein the target structure is prescribed as part of a classification of at least one of fundamental geometric and medical properties of the structure.

3. The method as claimed in claim 1, wherein the structure is a lesion.

4. The method as claimed in claim 1, wherein at least one of the structure, a segment and the subsegment are interactively selected.

5. The method as claimed in claim 4, wherein at least one of an assessment and sorting for the selection is produced.

6. The method as claimed in claim 1, wherein a 3D image display is produced in the form of a virtual endoscopy.

7. The method as claimed in claim 1, wherein the method starts from a 3D data volume obtained using a contrast agent.

8. The method as claimed in claim 1, wherein the method is performed for a medical method for image display and processing in at least one of computed tomography and magnetic resonance tomography.

9. The method as claimed in claim 1, wherein the method is for medical image display and processing of images of a colon.

10. The method as claimed in claim 1, wherein the method is for medical image display and processing of images of a bronchial tree.

11. The method as claimed in claim 1, wherein the method is for medical image display and processing of images of a cisterna.

12. At least one of a computed tomograph and magnetic resonance tomography, including at least one control element for performing the method steps as claimed in claim 1.

13. A workstation for image display and processing of at least one of computed tomography and magnetic resonance tomography images, including at least one control element for performing the method as claimed in claim 1.

14. A computer program product for image display and processing of at least one of computed tomography and magnetic resonance tomography images, including at least one program module for performing the method steps of the method as claimed in claim 1.

15. The method as claimed in claim 2, wherein the structure is a lesion.

16. The method as claimed in claim 1, wherein the method is for medical image display and processing of at least one of computed tomography and magnetic resonance tomography images.

17. An apparatus for automatically detecting a structure in an image, the apparatus comprising:
means for defining a target structure;
means for restricting a starting region, provided in a displayed image on the basis of a 3D data volume, to a search region including only an evaluation volume of interest;
means for segmenting the evaluation volume of interest into a number of subsegments of the evaluation volume of interest as part of a computer-automated search function;
means for restricting the evaluation volume of interest to a search region including a single subsegment of the evaluation volume of interest; and
means for automatically detecting a structure which is similar to the target structure in the search region.

18. The apparatus as claimed in claim 17, wherein the target structure is defined as part of a classification of at least one of fundamental geometric and medical properties of the structure.

19. The apparatus as claimed in claim 17, wherein the structure is a lesion.

20. The apparatus as claimed in claim 17, wherein at least one of the structure, a segment and the subsegment are interactively selected.
